(19) United States
(12) Patent Application Publication
(10) Pub. No.: US 2016/0244246 A1
(43) Pub. Date: Aug. 25, 2016

(54) BICYCLE STORAGE SYSTEM

(71) Applicant: GM Global Technology Operations LLC, Detroit, MI (US)

(72) Inventor: Gábor Gerencsér, Szekesfehervar (HU)

(21) Appl. No.: 14/631,328

(22) Filed: Feb. 25, 2015

(51) Int. Cl. B65D 85/68; B62K 15/00; B60R 11/00

(52) U.S. Cl. CPC B65D 85/68; B60R 11/00; B62K 15/008

(57) ABSTRACT

A number of variations may include storage of a folded bike in a storage box.

### TECHNICAL FIELD

The field to which the disclosure generally relates is folding bicycles.

### BACKGROUND

Bicycles may be folded for compact storage. The folding bicycle may include a rechargeable battery.

### SUMMARY OF ILLUSTRATIVE VARIATIONS

A number of variations may include storage of a folded bike in a storage box.

### BRIEF DESCRIPTION OF THE DRAWINGS

Select examples of variations within the scope of the invention will become more fully understood from the detailed description and the accompanying drawings.

FIG. 1 is a side view of the bicycle according to a number of variations.

FIG. 2 shows the bicycle of FIG. 1 folded to a position for easy rolling by the user according to a number of variations.

FIG. 3 shows the bicycle of FIG. 1 fully folded for compact storage according to a number of variations.

FIG. 4 is a perspective view of a storage box for the bicycle according to a number of variations.

FIG. 5 is a side elevation view of the storage box being slid into a vehicle according to a number of variations.

FIG. 6 shows the folded bicycle of FIG. 3 rolled into the storage box for storage according to a number of variations.

FIG. 7 shows a user towing the storage box along the ground according to a number of variations.

FIG. 8 shows an electrical schematic for connecting the electrical system of the vehicle to the battery of the bicycle for recharging the battery from the vehicle according to a number of variations.

### DETAILED DESCRIPTION OF ILLUSTRATIVE VARIATIONS

The following description of the variations is merely illustrative in nature and is in no way intended to limit the scope of the invention, its application, or uses.

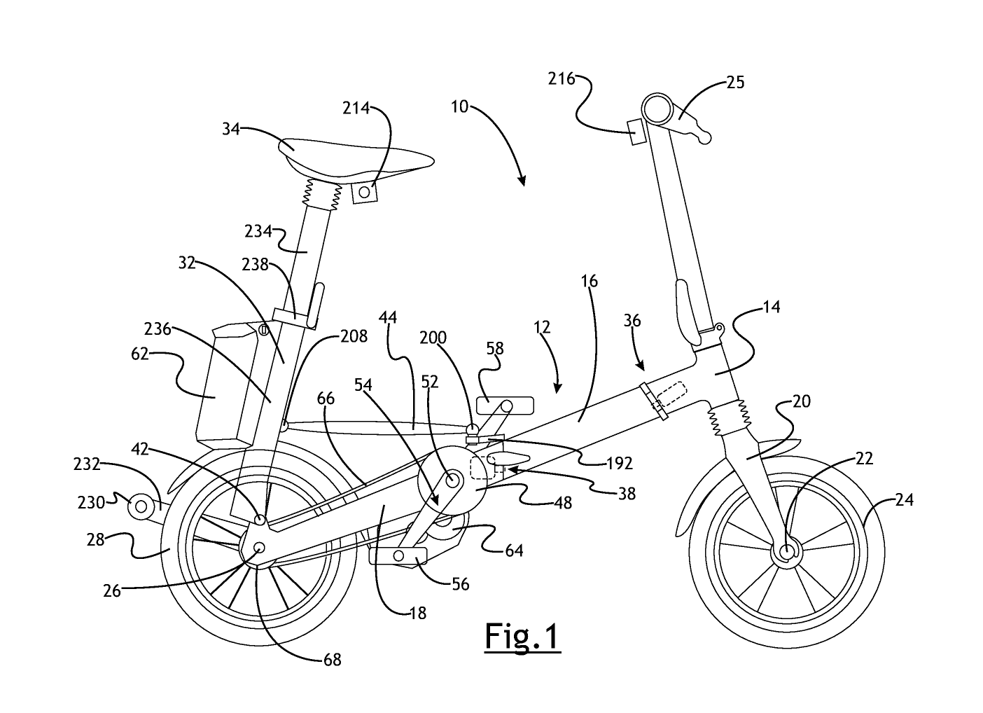

A number of variations are illustrated in FIG. 1, which may include a bicycle 10 including a frame, generally indicated at 12, which may include a front frame 14, a middle frame 16 and a rear frame 18. The front frame 14 may have a fork assembly 20 with front axle 22 that supports front wheel 24, and a handle bar assembly 25 by which a user will turn the front wheel 24 to turn the bicycle. The rear frame 18 may have a rear axle 26 that supports rear wheel 28 and a seat support 32 that supports a seat 34.

The front frame 14 may be connected to the middle frame 16 by a front hinge assembly, generally indicated at 36, that will be described further hereinafter. The rear frame 18 may be connected to the middle frame 16 by a rear hinge assembly, generally indicated at 38, that will be described hereinafter.

The seat support 32 may be pivotally connected to the rear frame 18 by a pivot 42, which may be located just above the rear axle 26. As seen in FIG. 1, a support rod 44 extends between the middle frame 16 and the seat support 32 to support the seat support 32 at its position of FIG. 1 so that the seat support 32 will not pivot about its pivot 42 during use of the bicycle 10.

The bicycle 10 may have an electrical propulsion system, as well as a traditional pedal system, so that the user can choose between electric powered riding and pedal powered riding. A chain sprocket 48 may be pivoted on sprocket axle 52 provided on the rear frame 18. A pedal assembly 54 including a right pedal 56 and left pedal 58 may be attached to the chain sprocket 48 by a one-way clutch, not shown. The electrical propulsion system may include a battery 62 suitably mounted on the seat support 32 and a motor 64 that is connected to the chain sprocket 48 by a one-way clutch, not shown. The chain sprocket 48 may be connected to the rear wheel 28 by a chain 66 and a rear sprocket 68.

The middle frame 16 may have a lever arm 192 that is attached to the top of the middle frame 16. As best seen in FIG. 6, this lever arm 192 may project sideways from the middle frame 16 and may be attached to the support rod 44 by a ball swivel joint 200. Referring again to FIG. 1, it is seen that the rear end of the support rod 44 may be attached to the seat support 32 by a similar ball swivel joint 208. It will be understood that upon a pivoting of the middle frame 16 about the rear hinge assembly 38, the lever arm 192 may rotate, thereby pulling or pushing support rod 44 which in turn may result in a pivoting of the seat support 32 about its pivot 42 to thereby move the seat support 32 either closer to or further away from the rear frame 18.

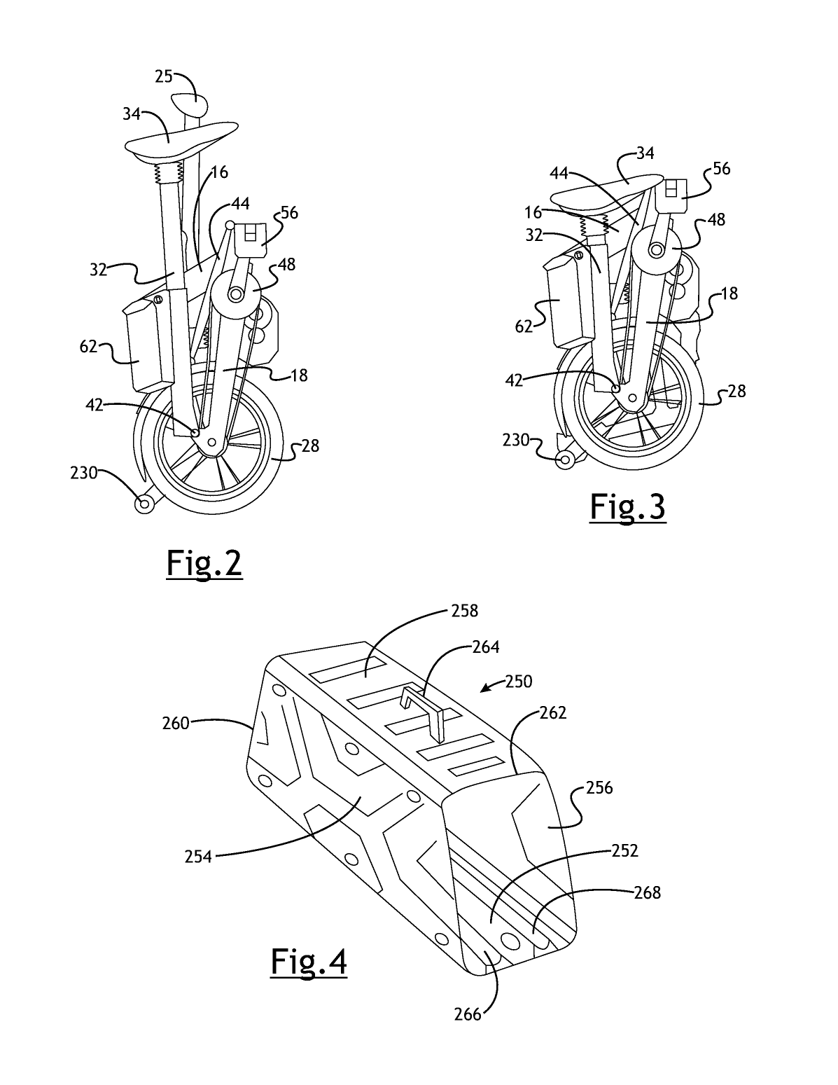

During such folding action, the middle frame 16 may swing about the rear hinge assembly 38 and the front frame 14 may swing about the front hinge assembly 36 so that the bicycle 10 obtains its folded position of FIG. 2 in which the front wheel 24 may have assumed a position that is side-by-side and parallel with the rear wheel 28, with a space of a few inches between the front and rear wheels. Both the front wheel 24 and the rear wheel 28 may be engaging the ground.

In comparing FIGS. 1 and 2, it is seen that during the pivoting of the rear hinge assembly 38, the lever arm 192 may have effectively pushed the seat support rod 44 rearwardly which may cause the seat support 32 to assume a more vertical position. Furthermore, as seen in FIGS. 1 and 2, the bicycle 10 may have a third wheel 230 that may be attached to the middle frame 18 by a wheel support bar 232. As seen in FIG. 2, the upward rotation of the rear frame 18 about the rear axle pivot 26 may have caused the third wheel 230 to be lowered into contact with the ground surface. Thus, as seen in FIG. 2, the bicycle 10 may now stand on its own and the user may be free to remove his hands from the seat 34 and the handlebar 25. All three wheels, including front wheel 24, rear wheel 28 and third wheel 230 may be engaging the ground. The contact of the third wheel 230 with the ground may allow the upright folded bicycle of FIG. 2 to be easily rolled along the ground surface, thus facilitating transport of the folded bicycle by the user.

FIG. 3 is another view of the bicycle 10 in which the folded bicycle of FIG. 2 may be further compacted by lowering the seat 34 and folding the handle bars 25. The seat support 32 may include telescoping rods including an upper tube 234 attached to the seat and a lower tube 236. A releasable clamp mechanism 238, shown in FIG. 1, may permit the seat 34 to be raised and lowered. The handlebar assembly 25 may include hinges for the left handlebar and right handlebar (not shown in the drawings) so that the handlebars may be folded downwardly. In addition, if desired, the right pedal 56 and the left pedal 58 may be of the pivoting type to permit folding to the collapsed position of FIGS. 2 and 3, further reducing the size of the folded bicycle 10.

FIG. 4 shows a storage box 250 for storing the bicycle 10 according to a number of variations. The storage box 250 may have a bottom wall 252, a left side wall 254, a right side wall 256, a top wall 258, a front wall 260, and an open end 262. The storage box 250 may be constructed of a lightweight material such as fiberglass or aluminum or other sheet metal. The walls may have integral stiffening ribs formed therein to strengthen the walls. The storage box may have a lift handle 264 at the top wall 258. A pair of tracks 266 and 268 may be provided on the bottom wall 252.

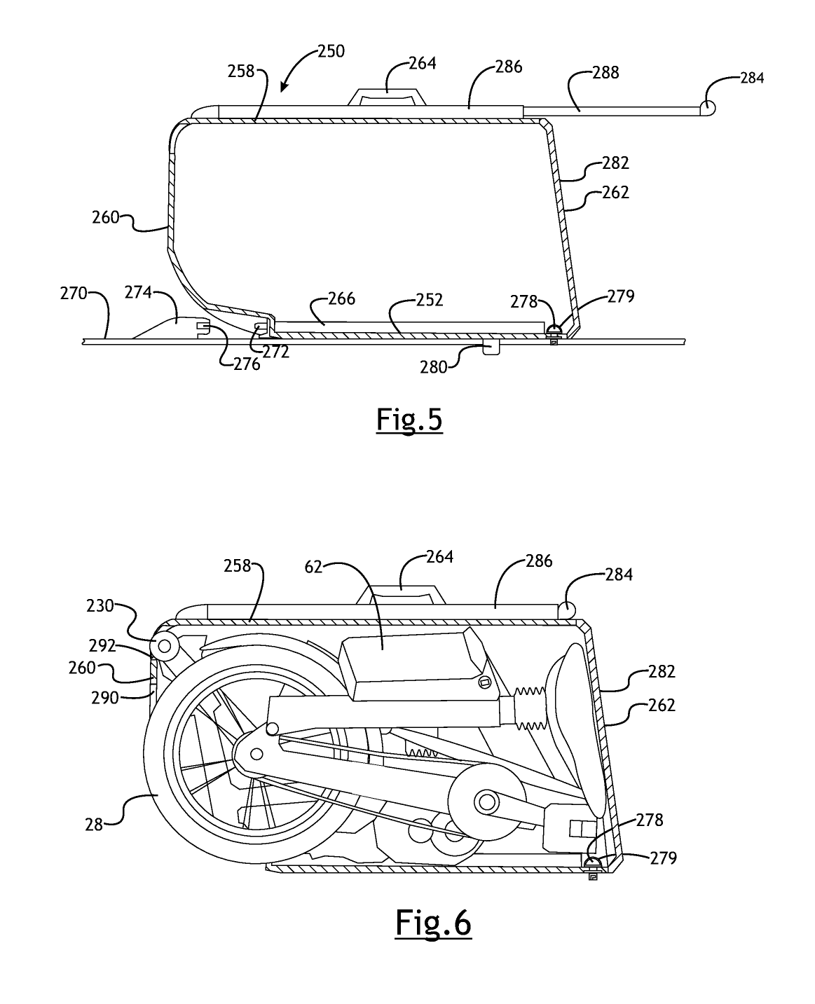

FIG. 5 shows the storage box 250 resting on the floor 270 of a vehicle. A guide pin 272 may be mounted on the storage box 250 on front wall 260 and projects forwardly. A guide pin receptacle 274 may be mounted on the floor 270 and have a socket 276 that opens rearwardly. When the storage box 250 is slid into the vehicle, the guide pin 272 will insert into the socket 276 of the guide pin receptacle 274 to provide a mechanical connection between the storage box 250 and the vehicle floor 270. The mechanical connection provided by engaging the guide pin 272 with the guide pin receptacle 274 will limit the forward sliding movement of the storage box 250 into vehicle and will retain the storage box 250 on the vehicle floor 270 during travel of the vehicle. One or more of these guide pin receptacles 274 and guide pins 272 may be utilized as desired and the guide pin 272 may be mounted on the vehicle as an alternative to mounting the guide pin 272 on the storage box 250.

As seen in FIG. 5, a manual latch 278 may be provided on the bottom wall 252 adjacent the open end 262 of the storage box 250 for manual operation by the user to provide an additional attachment of the storage box 250 to the vehicle. The manual latch 278 may, for example, be a quick-turn locking connector 279 that may lock into a mating cavity 280 provided in the floor 270 of the vehicle. One or more of these quick-turn locking connectors 279 may be utilized. Such quick-turn connectors, or other suitable manual latches, are commercially available and may be selected from manufacturer's catalogs. When the storage box 250 has been slid onto the vehicle, the mechanical connection provided by the guide pin 272 and the guide pin receptacle 274 will stop the forward sliding movement of the storage box 250 into the vehicle and bring the quick-turn locking connector 279 into alignment with the cavity 280, so that the quick-turn locking connector 279 will lock into the cavity 80. For removing the storage box 250 from the vehicle, the user may manually operate the quick-turn locking connector 279 a quarter turn and then lift the rear end of the storage box 250, so that the storage box 250 can be slid rearwardly and lifted out the vehicle.

As seen in FIG. 5, a removable lid 282 may be provided to close off the open end 262 of the storage box 250. FIG. 5 shows a tow handle 284 that may be mounted on the top wall 258 of the storage box 250. Tow handle 284 may be a telescoping handle and include an outer tube 286 mounted on the top wall 258 and an inner tube 288 that slides within the outer tube 286.

FIG. 6 shows the storage box 250 with the bicycle 10 rolled into the storage box 250. The front wheel 24 and the rear wheel 28 have rolled respectively along the tracks 266 and 268. The front wall 260 may have a slot 290 through which the rear wheel 28 may extend so at to extend outside of the storage box 250. The front wall 260 may also have a slot 292 through which the third wheel 230 may extend outside of the storage box 250. The front wall 260 may have an additional slot, not shown, through which the front wheel 24 may extend. The storage box 250 may have tie-down straps, cord, latches or other devices to hold the bicycle tightly in position within the storage box 250.

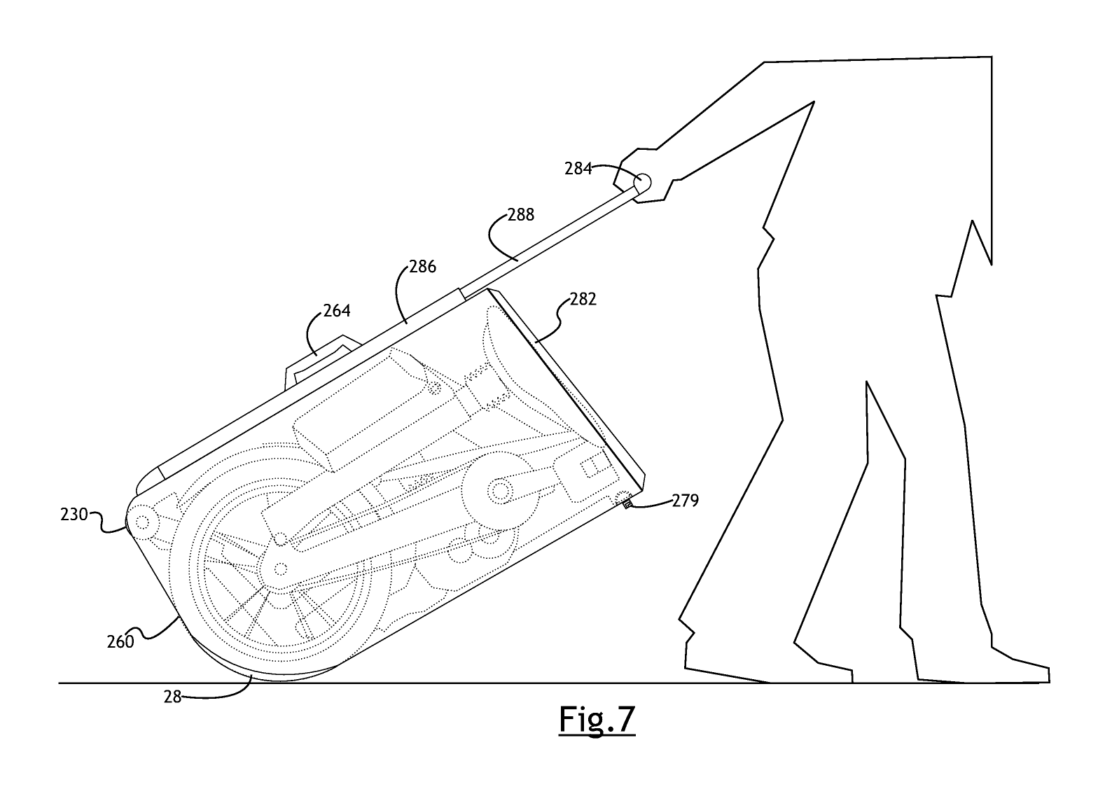

FIG. 7 shows the storage box 250 being towed along the ground by a user who is gripping the tow handle 284. The rear wheel 28 is extending through the slot 290 in the front wall 260 and is rolling on the ground. The user may also tip the storage box 250 vertically, so that the third wheel 230 and the rear wheel 28 are rolling on the ground.

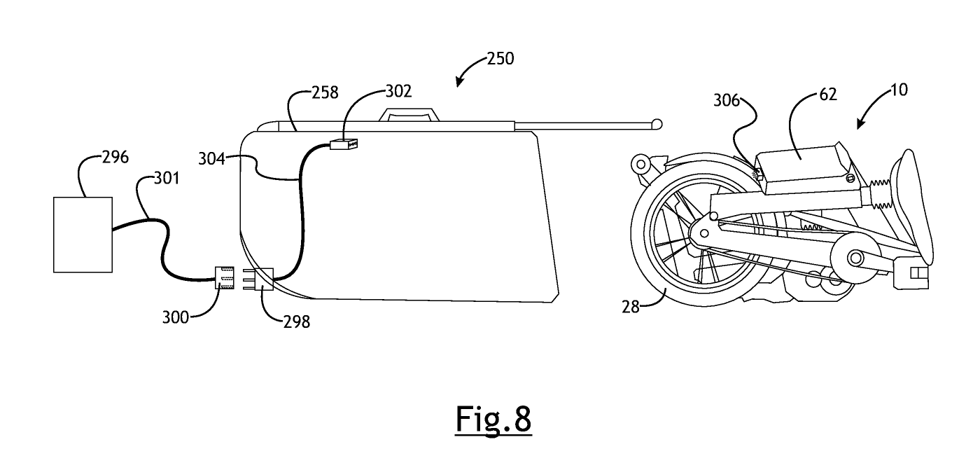

FIG. 8 is an electrical schematic for the storage box 250, and for making electrical connections between the vehicle, the storage box 250 and the bicycle 10 so that the vehicle electrical system may be used to recharge the battery 62 of the bicycle 10. The vehicle may have a charging source 296. A first electrical connector 298 may be fixedly mounted on the storage box 250. A mating electrical connector 300 may be fixedly mounted on the vehicle, for example on the vehicle floor 270, or on the guide pin receptacle 274. The mating connector 300 may be connected to the charging source 296 by a cable 301. Upon the sliding of the storage box 250 into the vehicle, and upon the guide pin 272 inserting into the guide pin receptacle 274 to stop the forward sliding movement of the storage box 250 relative the vehicle floor, the first electrical connector 298 may simultaneously engage with the mating electrical connector 300 to automatically make an electrical connection between the vehicle and the storage box 250 without additional effort by the user.

FIG. 8 also shows a second electrical connector 302 that may be fixedly mounted on the inside of the storage box 250 and connected to the first electrical connector 298 by cable 304. The bicycle 10 is also shown in FIG. 8 and is ready to be rolled into the storage box 250. The bicycle 10 may have a fixedly mounted mating electrical connector 306 that is electrically connected to the battery 62 of the bicycle 10. When the bicycle 10 is rolled into the storage box 250, the mating electrical connector 306 may be simultaneously engaged with the second electrical connector 302 without additional effort by the user as the bicycle us rolled into the storage box 250. The mating electrical connector 306 may be located at any convenient location on the bicycle 10, including directly on the battery 62. Alternatively, the second electrical connector 302 and the cable 304 may be loose and flexible within the storage box 250, rather than fixedly mounted on the box, and the user may manually connect the second electrical connector 302 to the mating electrical connector 306 provided on the bicycle 10.

It will be understood that the foregoing examples of variations are merely illustrative and many variations can be practiced. For example, more than one of the storage boxes can be stored in a vehicle, with two or more storage boxes mounted side-by-side or stacked one atop another. The storage box can easily be used as luggage to transport the bicycle on an airplane, train or bus. The transport vehicle, whether a highway vehicle, airplane, train, or bus can be equipped with the described electrical connection so that the bicycle may be recharged during transport. The particular charging controller electronics for controlling the recharge of the battery 62 can be mounted on the vehicle, or on the bicycle 10, or on the storage box 250.

Variation 1 may include a storage system for storing a folded bicycle in a vehicle comprising a box having an open end for receiving a folded bicycle; at least one track mounted within the box for guiding a wheel of the folded bicycle as the folded bicycle is rolled into the box; a mechanical connection having a first part carried by the box and a second part mounted on the vehicle, the first part carried by the box connecting with the second part mounted on the vehicle when the box is installed into the vehicle to connect the box to the vehicle.

Variation 2 may include a storage system as set forth in Variation 1 and further comprising the mechanical connection having a guide pin projecting forwardly from the box and the vehicle having a guide pin receptacle receiving the guide pin when the box is slid into the vehicle.

Variation 3 may include a storage system as set forth in any of Variations 1-2 and further comprising the box having a manually operable latch for engaging with the vehicle to attach the box to the vehicle.

Variation 4 may include a storage system as set forth in any of Variations 1-3 and further comprising the box having a lift handle for lifting the box into the vehicle.

Variation 5 may include a storage system as set forth in any of Variations 1-4 and further comprising the box having a slot through which a wheel of the bicycle extends outside of the box to engage a road surface.

Variation 6 may include a storage system as set forth in any of Variations 1-5 and further comprising a telescoping tow handle mounted on the storage box so that a user can tow the storage box along a road surface.

Variation 7 may include a storage system as set forth in any of Variations 1-6 and further comprising the box having a first electrical connector mounted thereon and engaging with a mating electrical connector mounted on the vehicle when the storage box is installed into the vehicle.

Variation 8 may include a storage system as set forth in any of Variations 1-7 and further comprising the box having a second electrical connector mounted thereon and engaging with a mating electrical connector mounted on the bicycle when the bicycle is rolled into the box for storage.

Variation 9 may include a storage system as set forth in any of Variations 1-8 and further comprising the box having a first track for guiding a front wheel of the bicycle and a second track for guiding a second wheel of the bicycle when the bicycle is rolled into the box.

Variation 10 may include a storage system as set forth in any of Variations 1-9 and further comprising the box having a removable lid for closing the open end of the box.

Variation 11 may include a storage system for storing a folded bicycle in a vehicle comprising: a box having an open end for receiving a folded bicycle having side-by-side front and rear wheels; a first track for guiding the front wheel of the bicycle and a second track for guiding the rear wheel of the bicycle when the bicycle is rolled into the box for storage; a mechanical connection having a first connecting part carried by the box and a second connecting part mounted on the vehicle, the first connecting part carried by the box sliding into and connecting with the second connecting part mounted on the vehicle when the box is installed into the vehicle to stop the sliding movement of the storage box into the vehicle, said mechanical connection being located at a front end of the box; and a manually operable latch carried by the box for engaging with the vehicle to attach the box to the vehicle, said manually operable latch aligning with a cavity on a vehicle floor for engagement therewith when the mechanical connection stops the sliding movement of the storage box on the floor.

Variation 12 may include a storage system as set forth in Variation 11 further comprising the box having a first electrical connector mounted thereon and engaging with a mating electrical connector mounted on the vehicle when the storage box is installed into the vehicle.

Variation 13 may include a storage system as set forth in any of Variations 11-12 and further comprising the box having a second electrical connector mounted thereon and engaging with a mating electrical connector mounted on the bicycle when the bicycle is rolled into the box for storage.

Variation 14 may include a storage system as set forth in any of Variations 11-13 and further comprising the box having a first electrical connector mounted thereon and engaging with a mating electrical connector mounted on the vehicle when the storage box is installed into the vehicle, and the box having a second electrical connector mounted thereon and engaging with a mating electrical connector mounted on the bicycle when the bicycle is rolled into the box for storage, whereby an electrical connection is made between the vehicle and the bicycle for recharging a battery carried by the bicycle.

Variation 15 may include a storage system as set forth in any of Variations 11-14 and further comprising the box having a lift handle for lifting the box into the vehicle, a slot through which a wheel of the bicycle extends outside of the box to engage a road surface, and a telescoping tow handle mounted on the storage box so that a user can tow the storage box along a road surface.

Variation 16 may include a storage system for storing a folded bicycle in a vehicle comprising a box having an open end for receiving a folded bicycle; at least one track mounted within the box for guiding a wheel of the folded bicycle as the folded bicycle is rolled into the box; a mechanical connection having a first connecting part carried by the box and a second connecting part mounted on the vehicle, the first connecting part carried by the box sliding into and connecting with the second connecting part mounted on the vehicle when the box is installed into the vehicle to stop the sliding movement of the storage box into the vehicle; the box having a first electrical connector mounted thereon and engaging with a mating electrical connector mounted on the vehicle when the storage box is installed into the vehicle.

Variation 17 may include a storage system as set forth in Variation 16 and further comprising the box having a second electrical connector mounted thereon and engaging with a mating electrical connector mounted on the bicycle when the bicycle is rolled into the box for storage whereby an electrical connection is made between the vehicle and the bicycle for recharging a battery carried by the bicycle.

Variation 18 may include a storage system as set forth in any of Variations 16-17 and further comprising the box having a manually operable latch for engaging with the vehicle to attach the box to the vehicle.

Variation 19 may include a storage system as set forth in any of Variations 16-18 and further comprising the box having a slot through which a wheel of the bicycle extends outside of the box to engage a road surface.

Variation 20 may include a storage system as set forth in any of Variations 16-19 further comprising the box having a slot through which one of the wheels of the bicycle extends outside of the box to engage a road surface, and a telescoping tow handle mounted on the storage box so that a user can tow the storage box along a road surface.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

What is claimed is:

1. A storage system for storing a folded bicycle in a vehicle comprising:
a box having an open end for receiving a folded bicycle;
at least one track mounted within the box for guiding a wheel of the folded bicycle as the folded bicycle is rolled into the box; and
a mechanical connection having a first part carried by the box and a second part mounted on the vehicle, the first part carried by the box connecting with the second part mounted on the vehicle when the box is installed into the vehicle to connect the box to the vehicle.

2. The storage system of claim 1 further comprising the mechanical connection having a guide pin projecting forwardly from the box and the vehicle having a guide pin receptacle receiving the guide pin when the box is slid into the vehicle.

3. The storage system of claim 1 further comprising the box having a manually operable latch for engaging with the vehicle to attach the box to the vehicle.

4. The storage system of claim 1 further comprising the box having a lift handle for lifting the box into the vehicle.

5. The storage system of claim 1 further comprising the box having a slot through which a wheel of the bicycle extends outside of the box to engage a road surface.

6. The storage system of claim 1 further comprising a telescoping tow handle mounted on the storage box so that a user can tow the storage box along a road surface.

7. The storage system of claim 1 further comprising the box having a first electrical connector mounted thereon and engaging with a mating electrical connector mounted on the vehicle when the storage box is installed into the vehicle.

8. The storage system of claim 7 further comprising the box having a second electrical connector mounted thereon and engaging with a mating electrical connector mounted on the bicycle when the bicycle is rolled into the box for storage.

9. The storage system of claim 1 further comprising the box having a first track for guiding a front wheel of the bicycle and a second track for guiding a second wheel of the bicycle when the bicycle is rolled into the box.

10. The storage system of claim 1 further comprising the box having a removable lid for closing the open end of the box.

11. A storage system for storing a folded bicycle in a vehicle comprising:
a box having an open end for receiving a folded bicycle having side-by-side front and rear wheels;
a first track for guiding the front wheel of the bicycle and a second track for guiding the rear wheel of the bicycle when the bicycle is rolled into the box for storage;
a mechanical connection having a first connecting part carried by the box and a second connecting part mounted on the vehicle, the first connecting part carried by the box sliding into and connecting with the second connecting part mounted on the vehicle when the box is installed into the vehicle to stop the sliding movement of the storage box into the vehicle, said mechanical connection being located at a front end of the box;
and a manually operable latch carried by the box for engaging with the vehicle to attach the box to the vehicle, said manually operable latch aligning with a cavity on a vehicle floor for engagement therewith when the mechanical connection stops the sliding movement of the storage box on the floor.

12. The storage system of claim 11 further comprising the box having a first electrical connector mounted thereon and engaging with a mating electrical connector mounted on the vehicle when the storage box is installed into the vehicle.

13. The storage system of claim 11 further comprising the box having a second electrical connector mounted thereon and engaging with a mating electrical connector mounted on the bicycle when the bicycle is rolled into the box for storage.

14. The storage system of claim 11 further comprising the box having a first electrical connector mounted thereon and engaging with a mating electrical connector mounted on the vehicle when the storage box is installed into the vehicle, and the box having a second electrical connector mounted thereon and engaging with a mating electrical connector mounted on the bicycle when the bicycle is rolled into the box for storage, whereby an electrical connection is made between the vehicle and the bicycle for recharging a battery carried by the bicycle.

15. The storage system of claim 11 further comprising the box having a lift handle for lifting the box into the vehicle, a slot through which a wheel of the bicycle extends outside of the box to engage a road surface, and a telescoping tow handle mounted on the storage box so that a user can tow the storage box along a road surface.

16. A storage system for storing a folded bicycle in a vehicle comprising a box having an open end for receiving a folded bicycle;
at least one track mounted within the box for guiding a wheel of the folded bicycle as the folded bicycle is rolled into the box;
a mechanical connection having a first connecting part carried by the box and a second connecting part mounted on the vehicle, the first connecting part carried by the box sliding into and connecting with the second connecting part mounted on the vehicle when the box is installed into the vehicle to stop the sliding movement of the storage box into the vehicle;
the box having a first electrical connector mounted thereon and engaging with a mating electrical connector mounted on the vehicle when the storage box is installed into the vehicle.

17. The storage system of claim 16 further comprising the box having a second electrical connector mounted thereon and engaging with a mating electrical connector mounted on the bicycle when the bicycle is rolled into the box for storage whereby an electrical connection is made between the vehicle and the bicycle for recharging a battery carried by the bicycle.

18. The storage system of claim 16 further comprising the box having a manually operable latch for engaging with the vehicle to attach the box to the vehicle.

19. The storage system of claim 16 further comprising the box having a slot through which a wheel of the bicycle extends outside of the box to engage a road surface.

20. The storage system of claim 16 further comprising the box having a slot through which one of the wheels of the bicycle extends outside of the box to engage a road surface, and a telescoping tow handle mounted on the storage box so that a user can tow the storage box along a road surface.
